(19) United States
(12) Patent Application Publication
(10) Pub. No.: US 2015/0138060 A1
(43) Pub. Date: May 21, 2015

(54) DISPLAY APPARATUS AND METHOD FOR CONTROLLING DISPLAY APPARATUS

(71) Applicant: CANON KABUSHIKI KAISHA, Tokyo (JP)

(72) Inventors: Daisuke Takayanagi, Kawasaki-shi (JP); Tomoyuki Ohno, Zama-shi (JP); Tomoki Kuroda, Fujisawa-shi (JP); Yoshiki Iwakiri, Ebina-shi (JP)

(21) Appl. No.: 14/538,961

(22) Filed: Nov. 12, 2014

(30) Foreign Application Priority Data
Nov. 19, 2013 (JP) 2013-239160

(51) Int. Cl. G09G 3/34; G02F 1/133; G02F 1/1335; G01J 1/42

(52) U.S. Cl. CPC G09G 3/3406; G01J 1/4204; G02F 1/13318; G02F 1/1336; G09G 2320/0626; G09G 2320/0233; G09G 2310/08
USPC 345/102

(57) ABSTRACT

a display apparatus, comprises a display panel; a backlight that illuminates the display panel; a vibration member that vibrates the display panel; and a control unit that controls the backlight, wherein the control unit enhances brightness of the backlight at least in a part of a predetermined period, including a timing when the vibration member starts vibration, to be higher than brightness outside the predetermined period.

### BACKGROUND OF THE INVENTION

1. Field of the Invention

The present invention relates to a display apparatus having a panel correction function.

2. Description of the Related Art

In recent popular display apparatuses, such as liquid crystal displays and organic EL (Electro luminescence) displays, such optical members as glass substrates and polarizing plates are used. As shown in FIG. 16, these optical members warp or bend when physical stress is applied due to self weight.

Moreover, frictional force may be generated in a portion indicated by the reference numeral 1 in FIG. 16 (contact portion of a cutting plane of the optical member and a fixed part) because of burrs generated during manufacture. As a result, the portion indicated by the reference numeral 2 (contact portion of the plane of the optical member and a fixed part) continuously warps or bends, and optical change is generated. In the case of FIG. 16, for example, display unevenness is generated in a segment indicated by the reference numeral 3, whereby color reproducibility and uniformity are diminished.

To solve this problem, a technique of disposing a vibration member inside a display so that warping and bending are solved by applying vibration to the optical member was invented. For example, as shown in FIG. 17, the vibration member adjacent to the fixed member is vibrated, whereby resilience is generated in a portion indicated by the reference numeral 4. As a result, warping and bending generated in the optical member can be relaxed, and display unevenness can be improved. This function is called the “panel correction function”.

For example, as a mechanism similar to this technique, Japanese Patent No. 4282226 discloses a camera which recovers the image quality by vibrating a built-in optical member.

### SUMMARY OF THE INVENTION

By applying the technique disclosed in Japanese Patent No. 4282226 to a display apparatus, the display unevenness generated in the display panel can be improved. But depending on the state of the display apparatus and the image that is currently being outputted, the generated-display unevenness may not stand out, and in such a case, the user cannot sufficiently confirm whether the display unevenness has been solved or not.

To solve this problem, it is necessary to control the correction of the display panel so that the user can visually recognize the display unevenness generated on the display panel easily.

With the foregoing in view, it is an object of the present invention to provide a technique which allows the user to visually recognize the effect of the correction easily in a display apparatus that has the function to correct the display panel.

The present invention in its one aspect provides a display apparatus, comprises a display panel; a backlight that illuminates the display panel; a vibration member that vibrates the display panel; and a control unit that controls the backlight, wherein the control unit enhances brightness of the backlight at least in a part of a predetermined period, including a timing when the vibration member starts vibration, to be higher than brightness outside the predetermined period.

The present invention in its another aspect provides a method for controlling a display apparatus which includes a display panel, a backlight that illuminates the display panel, and a vibration member that vibrates the display panel, the method comprises a correction step of vibrating the vibration member; and a brightness change step of enhancing the brightness of the backlight at least in a part of a predetermined period including a timing when the vibration member starts vibration, to be higher than the brightness outside the predetermined period.

The present invention in its another aspect provides a display apparatus, comprises a display panel; a vibration member that vibrates the display panel; and a control unit that periodically acquires an image and outputs the acquired image to the display panel, wherein the control unit decreases the update frequency of the image to be outputted to the display panel, at least in a part of a period when the vibration member is vibrating, to be less than the update frequency outside the period.

The present invention in its another aspect provides a method for controlling a display apparatus which includes a display panel, and a vibration member that vibrates the display panel, the method comprises an output step of periodically acquiring an image and outputting the acquired image to the display panel; and a correction step of vibrating the vibration member, wherein in the output step, the update frequency of the image to be outputted to the display panel is decreased at least in a part of a period when the vibration member is vibrating, to be less than the update frequency outside the period.

According to the present invention, the user can visually recognize the effect of the correction easily in a display apparatus that has the function to correct the display panel.

Further features of the present invention will become apparent from the following description of exemplary embodiments with reference to the attached drawings.

### BRIEF DESCRIPTION OF THE DRAWINGS

FIG. 1 is a diagram depicting the configuration of a display apparatus according to Embodiment 1;

FIG. 2 is a flow chart depicting the processing of the display apparatus according to Embodiment 1;

FIG. 3 is a time chart that indicates the brightness of the backlight of Embodiment 1;

FIG. 4 is a flow chart depicting the processing of the display apparatus according to Embodiment 2;

FIG. 5 is a time chart that indicates the brightness of the backlight of Embodiment 2;

FIG. 6 is a diagram depicting the configuration of a display apparatus according to Embodiment 3;

FIG. 7 is a flow chart depicting the processing of the display apparatus according to Embodiment 3;

FIG. 8 is a time chart that indicates the brightness of the back light of Embodiment 3;

FIG. 9 is a diagram depicting the configuration of a display apparatus according to Embodiment 4;

FIG. 10 is a flow chart depicting the processing of the display apparatus according to Embodiment 4;

FIG. 11A and FIG. 11B show a backlight brightness determination method according to Embodiment 4;

FIG. 12 is a diagram depicting the configuration of a display apparatus according to Embodiment 5;

FIG. 13 is a flow chart depicting the processing of the display apparatus according to Embodiment 5;

FIG. 14 is a flow chart depicting the processing of the display apparatus according to Embodiment 6;

FIG. 15 is a diagram depicting the configuration of a display apparatus according to Embodiment 7;

FIG. 16 is a diagram for describing warping of an optical member; and

FIG. 17 is a diagram for describing warping correction for an optical member by vibration.

### DESCRIPTION OF THE EMBODIMENTS

Embodiments of the present invention will now be described with reference to the drawings. In each embodiment, composing elements, of which reference numeral where the hundredth rank is different, essentially provide the same function, therefore a detailed description other than on difference is omitted.

### Embodiment 1

A display apparatus according to Embodiment 1 is a display apparatus that includes a function to correct a liquid crystal panel (hereafter called the “display panel”) by vibration, where the visibility of the display unevenness is improved by temporarily changing the brightness of the backlight before and after the timing of starting vibration.

The display unevenness refers to the state where display color or brightness becomes uneven due to the warping and bending of the display panel. For example, if the display panel is warped, light from the backlight leaks, and an area which looks partially bright is generated.

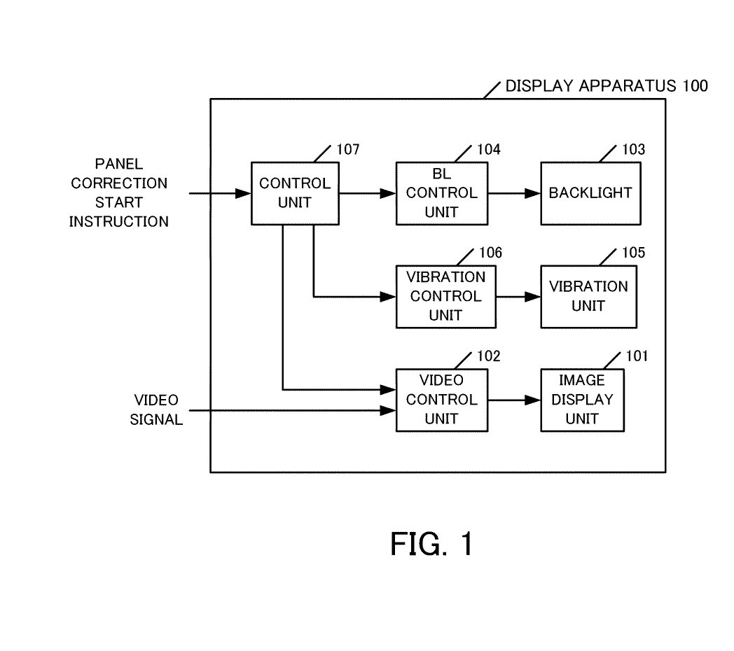

First the configuration of a display apparatus 100 according to Embodiment 1 will be described with reference to FIG. 1. The display apparatus 100 according to this embodiment includes an image display unit 101, a video control unit 102, a backlight 103, a BL control unit 104, a vibration unit 105, a vibration control unit 106 and a control unit 107.

The image display unit 101 is constituted by a display panel and a control circuit thereof, and is a unit to display an inputted image. The display panel may be a liquid crystal panel or an organic EL panel or the like.

The video control unit 102 is a unit to output a video signal acquired from the outside to the image display unit 101. In concrete terms, the video control unit 102 periodically receives a video signal from the outside, performs zoom processing, brightness adjustment processing, color processing or the like, and then outputs the processed-image at a cycle corresponding to a predetermined refresh rate (e.g. 60 Hz).

The backlight 103 is a unit that emits light by applying voltage, so as to illuminate such optical members as a liquid crystal panel and a diffusion plate. For the light emitting member of the backlight, a cathode ray tube (CCFL), a light emitting diode (LED) or the like is used. There are a plurality of types of backlight systems, such as a direct type and an edge light type, but the present invention can be applied to any light source and any system.

The BL control unit 104 is a unit that controls the backlight 103. For example, the BL control unit 104 can control the backlight ON/OFF and the brightness when the backlight emits light.

The vibration unit 105 is a unit to vibrate the display panel, and typically a motor (that is a vibrator), where a weight, of which center of gravity position is shifted, is attached to a rotary shaft. The vibration unit 105 can be rotated by applying voltage so as to generate vibration. The vibration unit 105 is preferably disposed near the display panel, particularly near a portion where warping and bending easily occur.

The vibration control unit 106 is a unit that acquires the panel correction execution instruction from the later mentioned configuration control unit 107, and corrects the display panel by controlling the voltage to be applied to the vibration unit 105. In this embodiment, “correction of the display panel” refers to an operation to vibrate the vibration unit 105 whereby vibration is applied to a part of the display panel.

The control unit 107 is a unit that controls the panel correction operation for the display apparatus 100 according to this embodiment, and specifically performs processing to acquire the display panel correction start instruction and processing to correct the display panel based on this instruction by vibrating the vibration unit 105 via the vibration control unit 106.

The control unit 107 also performs processing to change the brightness of the backlight via the BL control unit 104, and processing to output an image for correction to the image display unit 101 via the video control unit 102, when the display panel is corrected. The image for correction in this embodiment is assumed to be a uniform monochrome image on a full screen (hereafter called the “full screen monochrome image).

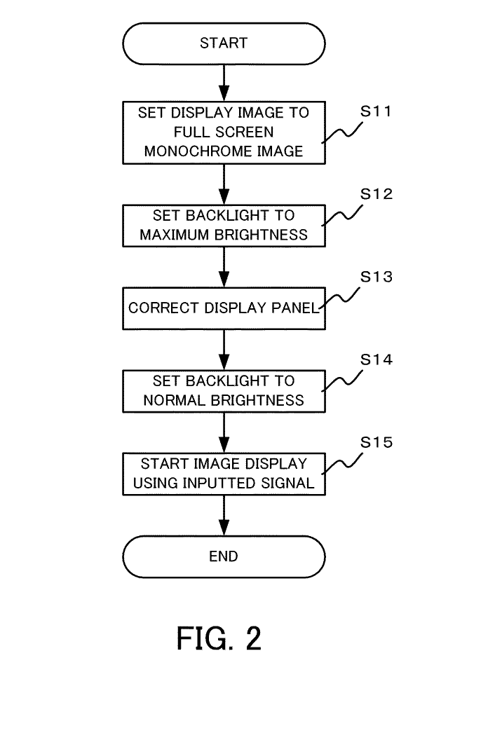

Now the specific content of the display panel correction processing performed by the control unit 107 will be described with reference to FIG. 2. The processing shown in FIG. 2 is started by the user pressing a correction button (not illustrated) disposed on the housing.

In step S11, the control unit 107 instructs the video control unit 102 to output the full screen monochrome image to the display panel, and the video control unit 102 outputs the full screen monochrome image to the image display unit 101. The image outputted here is an image where the RGB lightness of each pixel is zero (that is, an image filled in black). While the full screen monochrome image is being outputted, video signals outputted to the video control unit 102 are discarded.

Then in step S12, the control unit 107 instructs the BL control unit 104 to set the brightness of the backlight to the maximum, and the BL control unit 104 increases the current to be supplied to the backlight 103 to the maximum.

Then in step S13, the control unit 107 instructs the vibration control unit 106 to correct the display panel. Thereby the vibration control unit 106 supplies the vibration unit 105 with voltage only for a predetermined time (e.g. 10 seconds), and executes correction of the display panel.

Then in step S14, the control unit 107 instructs the BL control unit 104 to return the brightness of the backlight to the original state. Thereby the current to be supplied to the backlight 103 is returned to a value immediately before executing step S12.

Then in step S15, the control unit 107 notifies the end of the panel correction processing to the video control unit 102. Thereby the video control unit 102 stops outputting the full screen monochrome image and restarts processing an inputted video signal.

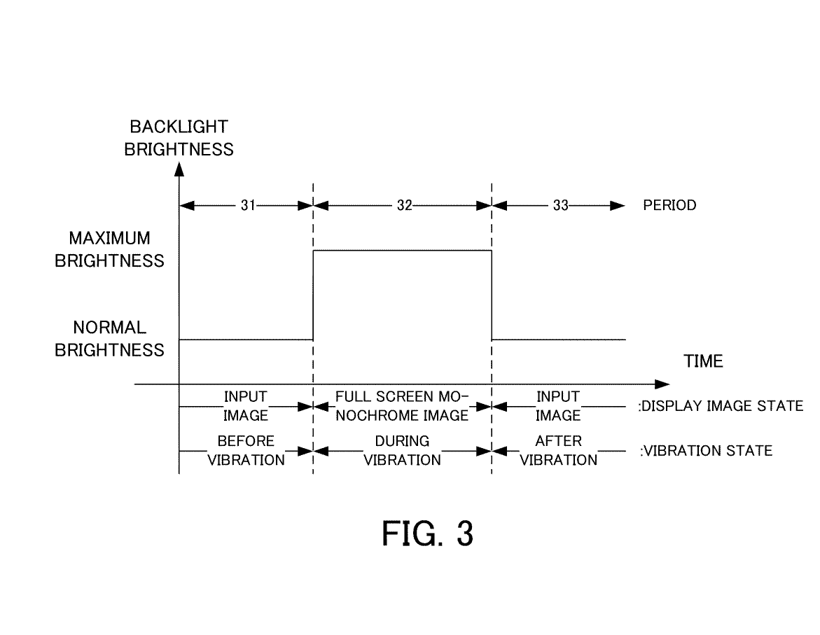

Now the change in brightness of the backlight during correction of the display panel will be described with reference to the time chart in FIG. 3.

In a period before the user instructs the start of the correction of the display panel (reference numeral 31), an image corresponding to the video signal inputted from the outside is displayed on the display panel, and the backlight emits light at a default brightness.

In a period when the vibration unit 105 is vibrating (reference numeral 32), a black image is displayed on the display panel, and the backlight lights at maximum brightness. In other words, in this state, display unevenness (e.g. leaking of light from the backlight) generated on the display panel can be observed most easily. In this period, the display panel is being corrected by the applied vibration, hence the user can visually recognize the state of the distribution of gray levels, which is gradually equalized.

After the correction of the panel ends (reference numeral 33), an image corresponding to the video signal inputted from the outside is displayed on the display panel, and the backlight emits light at a default brightness.

As described above, the display apparatus according to Embodiment 1 displays a monochrome image and performs control to maximize the brightness of the backlight while the display panel is being corrected. Thereby visibility of the display unevenness can be improved, and the user can confirm that the display unevenness was solved by the correction.

In this embodiment, the correction of the panel is started immediately after maximizing the brightness of the backlight, but the changing of the brightness of the backlight and the start of vibration need not be simultaneous. For example, a wait period may be inserted between steps S12 and S13 or between steps S13 and S14, so that a period for the user to confirm the presence of the display unevenness is created.

### Embodiment 2

In Embodiment 1, the control to maximize the brightness of the backlight is performed when correcting the display panel. In Embodiment 2 however, the brightness of the backlight is maximized immediately before starting the correction, and the correction is started after the brightness is returned to the original brightness.

The system configuration of the display apparatus 100 according to Embodiment 2 is the same as Embodiment 1, except for the method for controlling the backlight. Therefore only this difference will be described without showing the system block diagram.

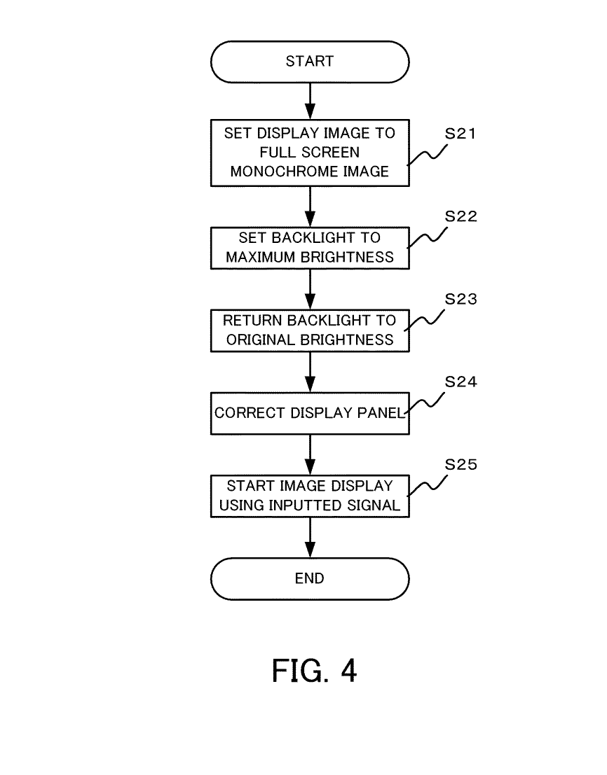

Processing when the control unit 107 according to Embodiment 2 executes the correction of the display panel will be described next with reference to the processing flow chart in FIG. 4. The processing shown in FIG. 4 is started by the user pressing a correction button (not illustrated) disposed on the housing.

The processing operations in step S21 and S22 are the same as steps S11 and S12 in Embodiment 1, therefore description thereof is omitted.

Then in step S23, the control unit 107 instructs the BL control unit 104 to return the brightness of the backlight to the original brightness for a predetermined time. Thereby the value of the current supplied to the backlight 103 is returned to the value immediately before executing step S22.

The processing operations in step S24 and S25 are the same as steps S14 and S15 in Embodiment 1, therefore description thereof is omitted.

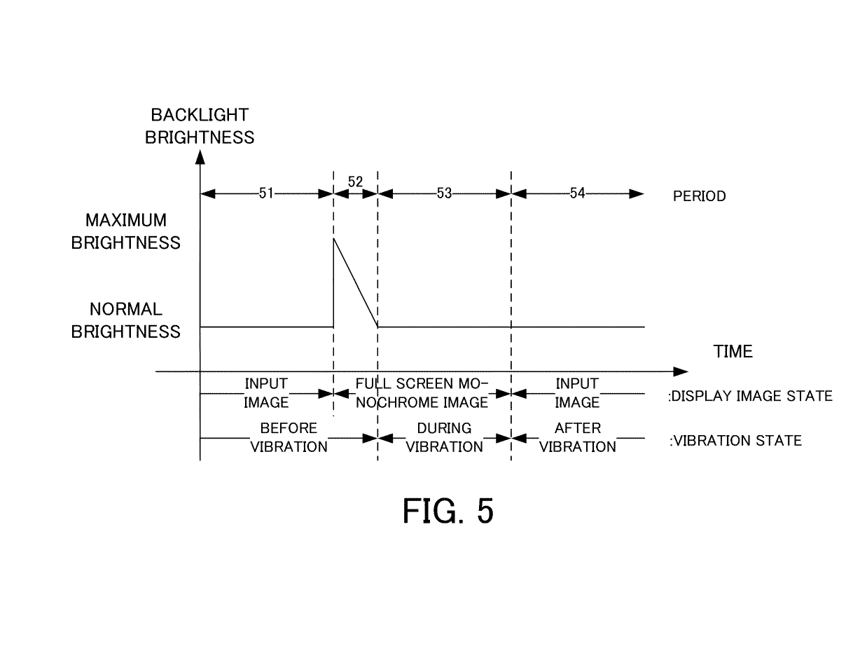

Now the change of the brightness of the backlight according to Embodiment 2 will be described with reference to the time chart in FIG. 5.

In the period before the user instructs for the panel correction (reference numeral 51), an image corresponding to the video signal inputted from the outside is displayed on the display panel, and the backlight emits light at a default brightness.

In the period after the user instructs the start of the panel correction until the start of vibration (reference numeral 52), a black image is displayed on the display panel, and after the backlight is lit at the maximum brightness, the brightness gradually returns to the original brightness. During this time, the user can visually recognize the distribution of the display unevenness, and can store this distribution information.

In the period from the start to the end of the vibration (reference numeral 53), a black image is displayed on the display panel, and the backlight emits light at a default brightness. Since the user has confirmed the distribution of the display unevenness in the period indicated by the reference numeral 52, the user can confirm [the display unevenness} with reference to this distribution. In other words, the user can recognize the state of the display unevenness, which is gradually being equalized by the vibration, even if the brightness of the backlight is not at the maximum.

After the panel correction ends (reference numeral 54), an image corresponding to the video signal inputted from the outside is displayed on the display panel.

As described above, according to Embodiment 2, the brightness of the backlight is temporarily enhanced immediately before starting the correction of the display panel. Thereby the visibility of the display unevenness can be improved, and the user can confirm that the display unevenness is solved by the correction.

### Embodiment 3

In Embodiment 3, the brightness of the backlight is enhanced to the maximum immediately before starting the correction of the display panel and immediately after the correction is ended, and the backlight is turned OFF during calibration. Furthermore, local dimming control of the backlight is performed.

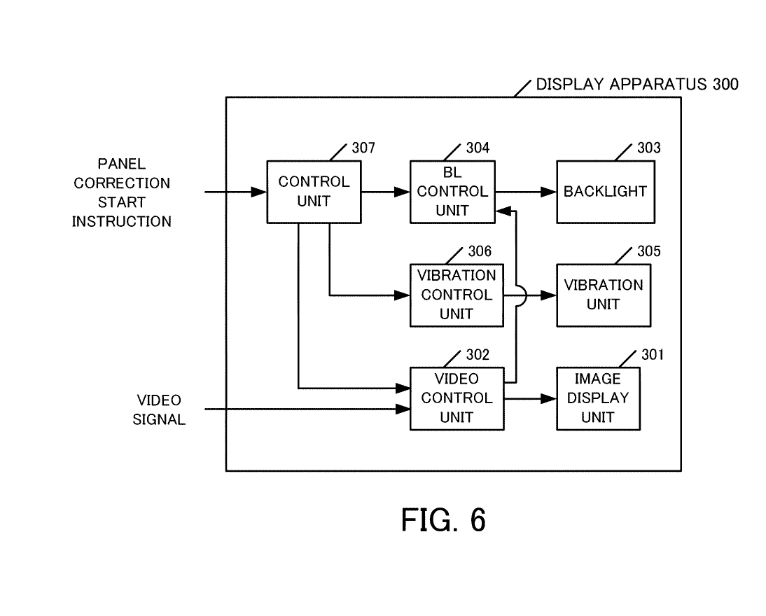

FIG. 6 shows the system configuration of the display apparatus 300 according to Embodiment 3. A difference between the display apparatus 300 according to Embodiment 3 and Embodiment 1 is that the backlight 303 is constituted by a plurality of LEDs and the brightness can be distributed by adjusting the amount of current that flows to each LED. This control is called the “local dimming control”.

In concrete terms, the video control unit 302 transmits information for performing the local dimming control to a BL control unit 304 according to the image that is output, and the BL control unit 304 controls the brightness distribution of the backlight 303 based on this information. Details on the local dimming control is omitted since this is a known technique.

Another difference is the method of controlling the backlight, which is performed by the control unit 307.

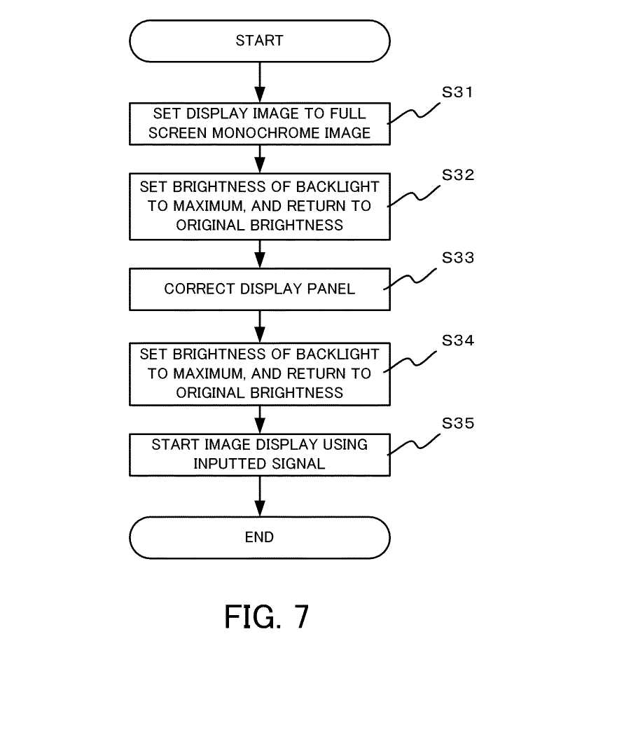

Processing when the control unit 307 according to Embodiment 3 executes the correction of the display panel will be described next with reference to the processing flow chart in FIG. 7. The processing shown in FIG. 7 is started by the user pressing the correction button (not illustrated) disposed on the housing.

The processing in step S31 is the same as step S11 in Embodiment 1, therefore description thereof is omitted.

Then in step S32, the control unit 307 instructs the BL control unit 304 to enhance the brightness of the backlight to the maximum, and to turn it OFF after a predetermined time. Thereby the value of the current supplied to the backlight 303 becomes the maximum, and is turned OFF after a predetermined time.

The processing in step S33 is the same as step S13 in Embodiment 1, therefore description thereof is omitted.

Then in step S34, the control unit 307 instructs the BL control unit 304 to enhance the brightness of the backlight to the maximum, and to return the brightness to the original brightness after a predetermined time. Thereby the value of the current supplied to the backlight 303 becomes the maximum, and is returned to the value immediately before executing step S32.

The processing in step S35 is the same as step S15 in Embodiment 1, therefore description thereof is omitted.

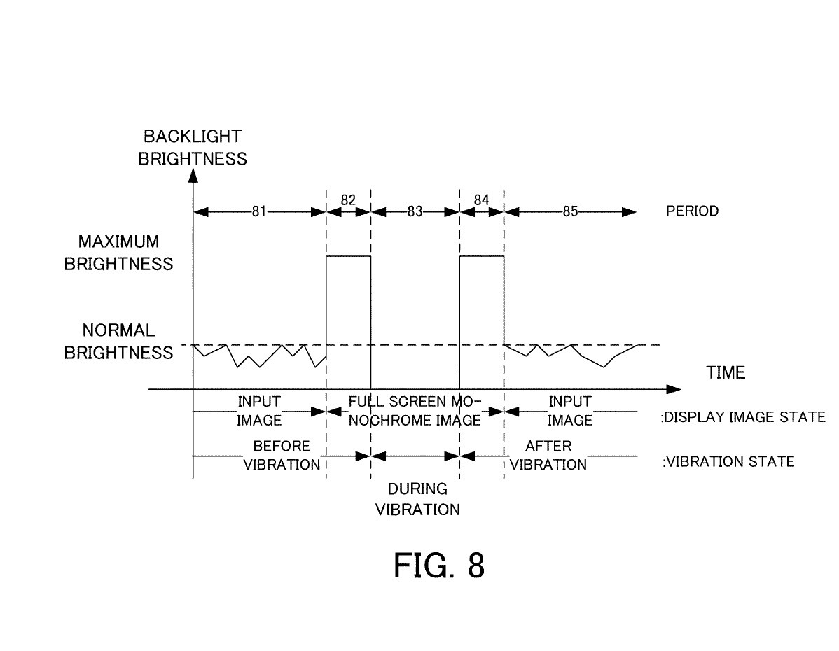

Now the change of the brightness of the backlight according to Embodiment 3 will be described with reference to the time chart in FIG. 8.

In the period before the user instructs to start the panel correction (reference numeral 81), an image corresponding to the video signal inputted from the outside is displayed on the display panel, and the brightness of the backlight is controlled by local dimming.

In the period after the user instructs to start the panel correction until the start of the vibration (reference numeral 82), a black image is displayed on the display panel, and the backlight is lit at the maximum brightness. During this time, the user can visually recognize the distribution of the display unevenness, and store this distribution information.

In the period from the start to the end of the vibration (reference numeral 83), the backlight is OFF.

In the period immediately after the end of the panel correction (reference numeral 84), the backlight is lit at the maximum brightness. During this period, the user can confirm that the display unevenness problems is solved.

After the panel correction ends (reference numeral 85), an image corresponding to the video signal inputted from the outside is displayed on the display panel, and the local dimming control for the backlight is started again.

As described above according to Embodiment 3, the brightness of the backlight is temporarily enhanced to a maximum level immediately before and immediately after the correction of the display panel, and the backlight is OFF during this correction. In this embodiment, the user does not visually recognize the changes of the display unevenness during the correction, therefore how the display unevenness changed before and after the vibration can be more clearly recognized.

### Embodiment 4

In Embodiment 1, the control to maximize the brightness of the backlight is performed when correcting the display panel. In Embodiment 4 however, the target brightness of the backlight during correction is determined considering the lightness around the apparatus.

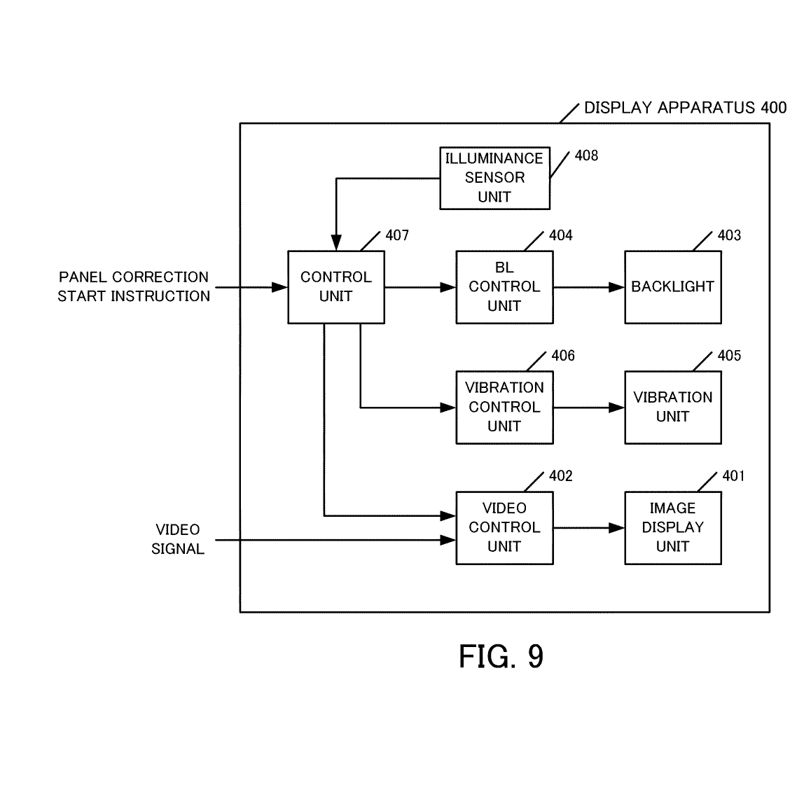

FIG. 9 shows the system configuration of the display apparatus 400 according to Embodiment 4. The difference between the display apparatus 400 according to Embodiment 4 from Embodiment 1 is that an illuminance sensor unit 408, which is a unit to detect the intensity of the ambient light, is included, and the control unit 407 determines the brightness of the backlight during correction according to the intensity of the ambient light.

The illuminance sensor unit 408 includes a photosensor of which output voltage changes according to the intensity of the ambient light around the apparatus, and converts the output voltage of the photosensor to a digital signal, and acquires the value after the conversion (hereafter called the “ambient light value”). The photosensor is attached to the front face of the liquid crystal display apparatus, for example.

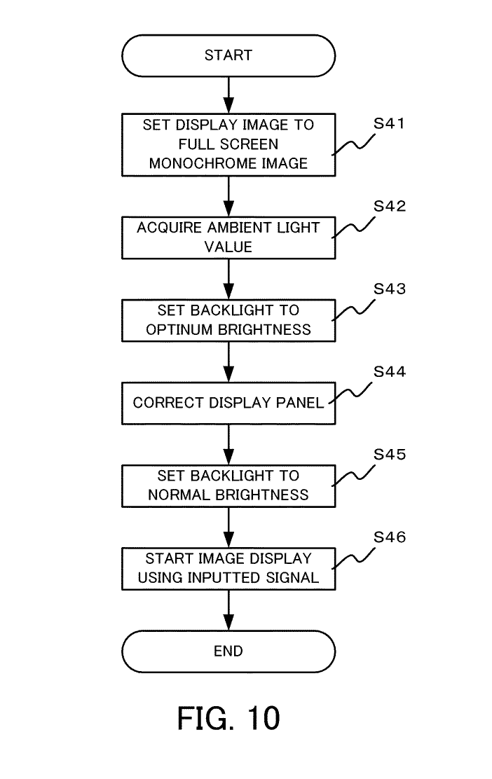

Processing when the display apparatus 400 according to this embodiment executes the correction of the display panel will be described next with reference to the processing flow chart in FIG. 10. The processing shown in FIG. 10 is started by the user pressing the correction button (not illustrated) disposed on the housing.

The processing in step S41 is the same as step S11, therefore description thereof is omitted.

Then in step S42, the control unit 407 acquires the ambient light value from the illuminance sensor unit 408, and in step S43, the control unit 407 determines the brightness of the backlight during correction based on the acquired ambient light value (hereafter called the “optimum brightness”).

Now the method for determining the optimum brightness of the backlight will be described.

In this embodiment, it is assumed that a BL control unit 404 can adjust the brightness value of the backlight in a 0 to 1000 range, and the illuminance sensor unit 408 can acquire the ambient light value in a 0 to 1000 range as well.

In this embodiment, a configuration control unit 407 stores information to indicate the correspondence between the ambient light value and the optimum brightness (hereafter called the “brightness determination information”), and determines the optimum brightness of the backlight using this information.

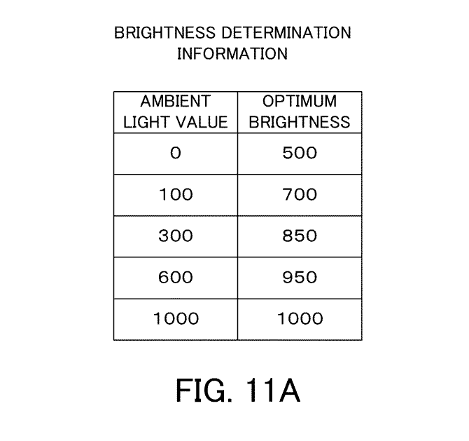

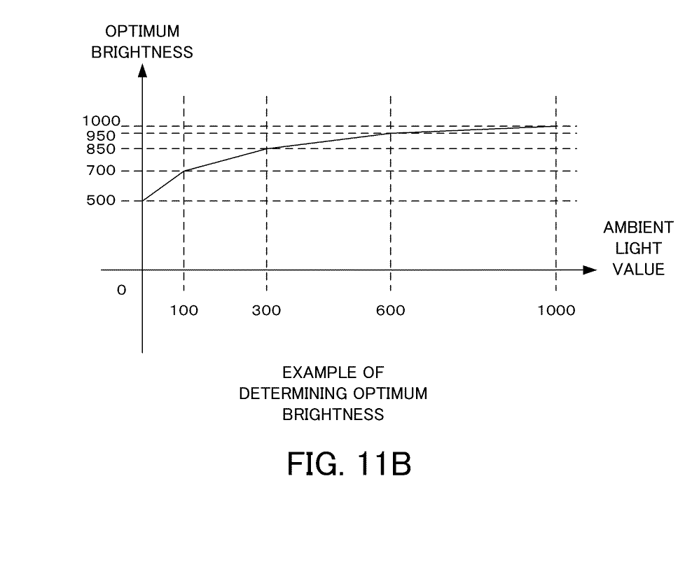

FIG. 11A shows an example of the brightness determination information. The brightness determination information is information on the optimum backlight brightness according to the ambient light, which is defined in advance. For example, the optimum brightness is 700 when the ambient light value is 100. This value is preferably not too light or too dark in order to visually recognize the display unevenness.

If the ambient light value is a value that is not listed here, the optimum brightness is determined using the linear interpolation shown in FIG. 11B. For example, if the ambient light is 200, then the optimum brightness is determined using the following calculation formula.

700+(200−100)/(300−100)×(850−700)=775

Alternately, the optimum brightness may be determined by calculation with storing a function to output a respective optimum brightness when an ambient light value is inputted.

When the optimum brightness determined in this step does not reach the current brightness, the processing may be stopped, or the processing may be continued using the maximum brightness instead of the optimum brightness. The user may select the operation.

The processing operations in step S44 to S46 are the same as steps S13 to S15, therefore description thereof is omitted.

The change of the brightness of the backlight during the panel correction in the present embodiment is the same as Embodiment 1 (FIG. 3), except that the optimum brightness is used instead of the maximum brightness.

(Effects and Modifications of Embodiment 1 to 4)

As described above, in Embodiments 1 to 4, the visibility of the display unevenness can be improved by enhancing the emission brightness of the backlight at a certain timing in a predetermined period, including the timing when the vibration unit starts vibration.

The “predetermined period” can be any period that is desirable for the user to check the display unevenness. For example, the control may be performed such that the brightness of the backlight becomes high at any timing within three seconds before and two seconds after the start of the vibration, totaling five seconds.

The target brightness value when the brightness is enhanced may be a value other than the example here, if the value is higher than the brightness outside the predetermined period (normal brightness).

In Embodiments 1 to 4, the transmittance of the display panel is decreased by displaying the full screen monochrome image, but the transmittance may be decreased using another method, or by using another method along with this method. For example, the lightness, contrast or chroma of the image or the display panel may be changed.

In Embodiments 1 to 4, the brightness is changed by changing the value of the current that flows to the backlight, but the brightness may be changed by changing the duty ratio (ratio of the light ON period in the control cycle) of the backlight.

In Embodiments 1 to 4, the liquid crystal display apparatus was described as an example, but each embodiment can be applied to any display apparatus as long as the display apparatus includes an optical member (e.g. glass substrate, thin film transistor) on the front of the backlight light source.

### Embodiment 5

The display apparatuses according to Embodiments 5 to 7 are display apparatuses that have a function to correct the display panel by vibration, where the visibility of the display unevenness is improved not by changing the brightness of the backlight, but by decreasing the update frequency of the image to be displayed.

“Decreasing the update frequency” does not always mean decreasing the refresh rate of the screen, but simply means visually decreasing a number of times of updates per unit time of the image displayed on the display panel. For example, the refresh rate of the screen may be decreased, or the same image may be repeatedly outputted without changing the refresh rate.

In Embodiment 5, a still image is displayed by stopping the update of the image, and repeatedly outputting an image in a specific frame when correcting the display panel.

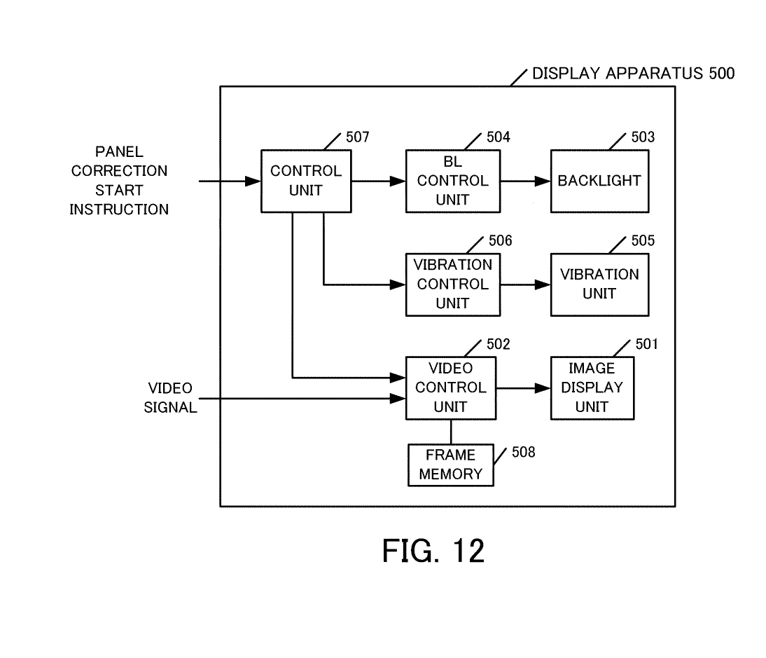

The configuration of the display apparatus according to Embodiment 5 will now be described with reference to FIG. 12. The display apparatus 500 according to this embodiment includes an image display unit 501, a video control unit 502, a backlight 503, a BL control unit 504, a vibration unit 505, a vibration control unit 506, a control unit 507 and a frame memory 508.

The image display unit 501, the backlight 503, the BL control unit 504, the vibration unit 505, and the vibration control unit 506 are the same as Embodiment 1, therefore description thereof is omitted. The control unit 507 is the same as Embodiment 1, except that the function to change the brightness of the backlight is not included.

The video control unit 502 is a unit to acquire a video signal from the outside, and convert it into an image having the resolution and the number of colors matching the image display unit 501. Thereby images can be outputted at a predetermined refresh rate (e.g. 60 Hz, 48 Hz).

The frame memory 508 is a memory to temporarily store an image to be outputted to the image display unit 501.

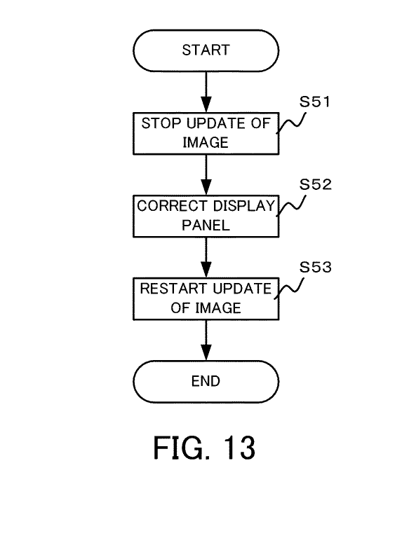

Processing when the display apparatus 500 according to Embodiment 5 executes correction of the display panel will be described next with reference to the processing flow chart in FIG. 13.

First in step S51, the control unit 507 transmits a request to stop the update of the image (hereafter called the “still image display request”) to the video control unit 502. When the still image display request is received, the video control unit 502 stores one frame of the acquired image to the frame memory 508, reads the stored image at each refresh rate, and transmits it to the image display unit 501. In other words, the image to be display becomes a still image, since the same image is repeatedly transmitted to the image display unit 501.

The processing in step S52 is the same as step S12 in Embodiment 1, therefore description thereof is omitted.

Then in step S53, the control unit 507 transmits a request to restart the update of the image to the video control unit 502. Thereby the video control unit 502 discards the images stored in the frame memory 508, and sequentially displays an image corresponding to the inputted video signal.

As described above, according to Embodiment 5, the visibility of the display unevenness can be improved by making the image outputted to the display panel a still image during the correction of the display panel.

When the image is generated as a still state, a message that the image will be displayed as a still image may be notified to the user using an onscreen display or the like, or a similar notification may be sent via the computer outputting the video signal.

### Embodiment 6

In Embodiment 6, the refresh rate is decreased when correcting the display panel. For example, if the vertical synchronous frequency of the inputted video signal is 60 Hz (to be specific, 59.964 Hz), then the number of times to update the image per second is set to a value less than 60 (e.g. 6 times). In this example, it is assumed that a predetermined refresh rate is 60 Hz.

The system configuration of the display apparatus according to Embodiment 6 is the same as Embodiment 5, except for the control method of the refresh rate, therefore only this difference will be described without showing a separate system block diagram.

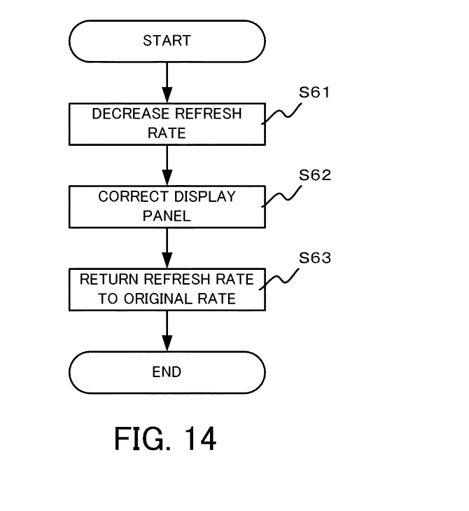

Processing when the display apparatus 500 according to Embodiment 6 executes the correction of the display panel will be described with reference to the processing flow chart in FIG. 14.

First in step S61, the control unit 507 transmits an instruction to decrease the refresh rate of the image to the video control unit 502. By this instruction, the refresh rate is set to 1/10 (6 Hz) of the predetermined value, for example.

In the period when the refresh rate is changed, the video control unit 502 writes the acquired image to the frame memory 508 at a cycle (6 times per second) that corresponds to the refresh rate after the change, reads the image at this same cycle, and transmits it to the image display unit 501.

By performing this processing on the inputted video signal (60 Hz), the image displayed on the display panel becomes an image of which number of frames has been reduced 1/10.

The processing in step S62 is the same as step S12 in Embodiment 1, therefore description thereof is omitted.

When the correction of the display panel ends, the control unit 507 transmits an instruction to the video control unit 502 in step S63 to return the refresh rate to the original rate. Thereby the video control unit 502 discards the data stored in the frame memory 508 and restarts the output of the image at the predetermined refresh rate (60 Hz).

According to Embodiment 6, the refresh rate is decreased when the display panel is corrected, so as to display the image with a number of updates that is less than the normal time. Thereby the state can be closer to the still image state, and visibility of the display unevenness can be improved.

### Embodiment 7

In Embodiment 5, the update of the image is stopped and a still image is outputted when correcting the display panel. In Embodiment 7 however, each image corresponding to a plurality of frames inputted during a predetermined period is analyzed, so that a frame, with which the effect of improving the display unevenness can be visually recognized most easily, is selected, and the still image is displayed using the image corresponding to this frame.

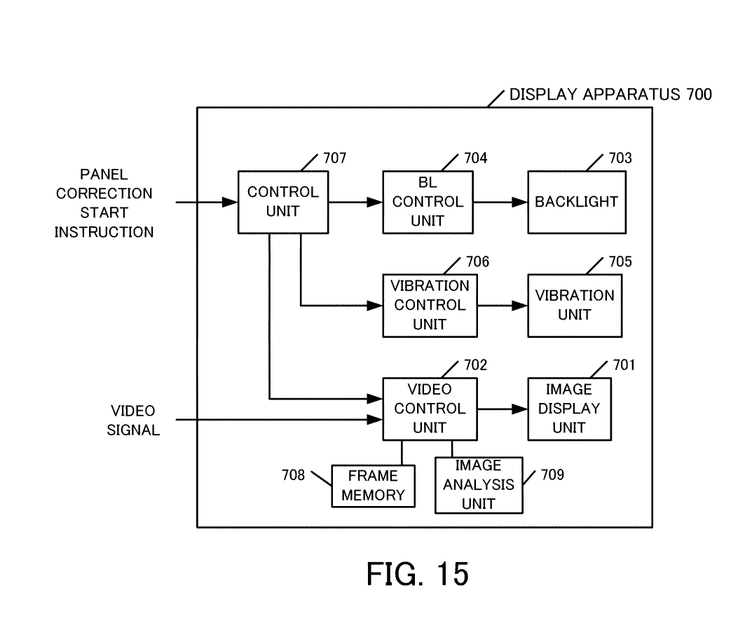

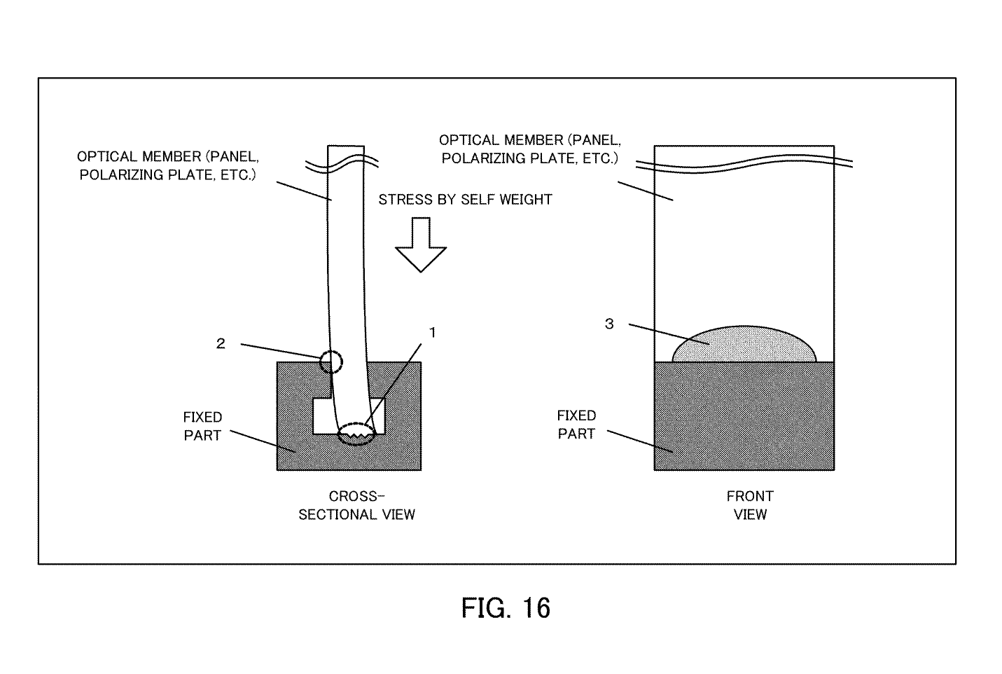

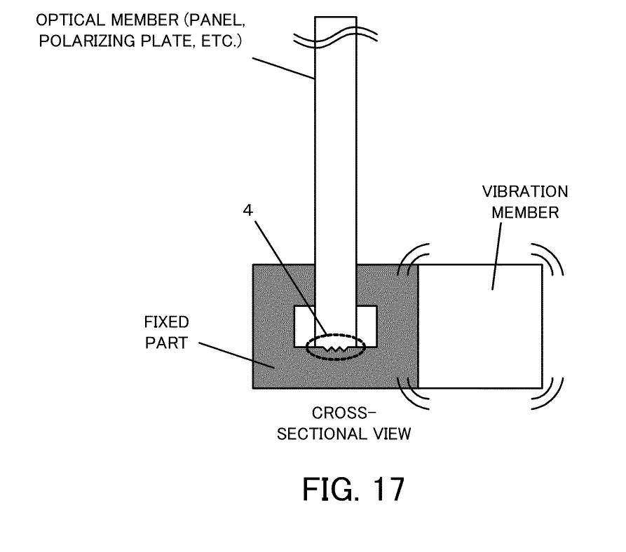

FIG. 15 shows a configuration of the display apparatus 700 according to Embodiment 7. The difference of the display apparatus 700 according to Embodiment 7 from Embodiment 5 is that an image analysis unit 709, which is a unit to analyze an image, is further included.

The processing of the display apparatus 700 according to Embodiment 7 is the same as FIG. 13, except that in the processing in step S51, a frame that satisfies the conditions is selected out of a plurality of frames inputted during a predetermined period, and an image corresponding to this frame is used as the still image. The difference from step S51 will now be described.

When a still image display request is received, the image control unit 702 acquires a predetermined number of frames (e.g. 180 frames) of images, and stores these images to the frame memory 708. Then the video control unit 702 transmits an analysis request, to analyze the plurality of stored images, to the image analysis unit 709.

The image analysis unit 709 analyzes the plurality of stored images, calculates the average brightness level of each image, and transmits the analysis result to the video control unit 702. In concrete terms, an image of which average brightness level is lowest is determined, and an identifier thereof is transmitted to [the video control unit 702].

Then the video control unit 702 acquires the image corresponding to this identifier from the frame memory 708, and uses it as the still image. The rest of the processing is the same as step S51.

According to Embodiment 7, an image of which brightness is lowest among a plurality of inputted images is used as the still image, therefore the image can be stopped in a frame by which the display unevenness can be most easily confirmed.

The image to be used as the still image may be determined based on a factor other than the brightness. For example, each image is converted into a frequency domain, and an image that includes the largest amount of the lowest frequency components may be used as the still image. Any method can be used as long as a frame suitable for checking the display unevenness can be specified in this manner.

In this embodiment, only one image is used as the still image, but a plurality of images may be used. For example, if there is a plurality of frames of which average brightness is lower than the threshold, the plurality of frames may be repeatedly displayed. Further, an effect the same as slow motion playback may be acquired by increasing the output interval of images.

(Effects and Modifications of Embodiments 5 to 7)

As described above, in Embodiments 5 to 7, the visibility of the display unevenness can be improved by decreasing the update frequency of the images displayed on the display panel while the vibration member is vibrating.

The period when the update frequency of the image is decreased is at least a part of the period when the vibration member is vibrating, and is preferably a time required for solving the display unevenness. For example, 10 seconds from the vibration start timing may be set.

To visually recognize the display unevenness more easily, contrast and chroma of the image to be outputted may be controlled to be higher, compared with the period before the start of the correction, when correcting the display panel.

The description of the embodiments is illustrative for the description of the present invention. The embodiments may be appropriately changed or combined together without departing from the spirits of the invention.

For example, the present invention may be implemented as a display apparatus including at least some of the above-described processes. Furthermore, the present invention may be implemented as a method for controlling the display apparatus which method includes at least some of the above-described processes. The above-described processes and units may be freely combined together for implementation provided that the combination leads to no technical inconsistency.

In each embodiment, the liquid crystal display was described as an example, but the present invention can also be applied to a display apparatus having an organic EL display, or a display apparatus having any other display. The present invention can be applied to any display apparatus only if an optical member, such as a display panel, glass substrate and a polarizer, is included.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-239160, filed on Nov. 19, 2013, which is hereby incorporated by reference herein in its entirety.

What is claimed is:

1. A display apparatus, comprising:
a display panel;
a backlight that illuminates the display panel;
a vibration member that vibrates the display panel; and
a control unit that controls the backlight, wherein
the control unit enhances brightness of the backlight at least in a part of a predetermined period, including a timing when the vibration member starts vibration, to be higher than brightness outside the predetermined period.

2. The display apparatus according to claim 1, wherein
the control unit enhances the brightness of the backlight while the vibration member is vibrating.

3. The display apparatus according to claim 1, wherein
the control unit enhances the brightness of the backlight only for a predetermined time before the vibration member starts vibration.

4. The display apparatus according to claim 3, wherein
the control unit enhances the brightness of the backlight only for a predetermined time after the vibration member ends vibration.

5. The display apparatus according to claim 4, wherein
the control unit turns the backlight OFF while the vibration member is vibrating.

6. The display apparatus according to claim 1, further comprising an illuminance sensor that detects an intensity of an ambient light, wherein
the control unit determines target brightness when enhancing the brightness of the backlight, based on output of the illuminance sensor.

7. A method for controlling a display apparatus which includes a display panel, a backlight that illuminates the display panel, and a vibration member that vibrates the display panel,
the method comprising:
a correction step of vibrating the vibration member; and
a brightness change step of enhancing the brightness of the backlight at least in a part of a predetermined period including a timing when the vibration member starts vibration, to be higher than the brightness outside the predetermined period.

8. A display apparatus, comprising:
a display panel;
a vibration member that vibrates the display panel; and
a control unit that periodically acquires an image and outputs the acquired image to the display panel, wherein
the control unit decreases the update frequency of the image to be outputted to the display panel, at least in a part of a period when the vibration member is vibrating, to be less than the update frequency outside the period.

9. The display apparatus according to claim 8, wherein
the control unit repeatedly outputs a specific image among the inputted images to the display panel as a still image, at least in a part of a period when the vibration member is vibrating.

10. The display apparatus according to claim 9, wherein
the control unit analyzes a plurality of images inputted during a predetermined period, and determines an image to be used as the still image, based on the analysis result.

11. The display apparatus according to claim 10, wherein
the control unit calculates the brightness level of a plurality of images inputted during a predetermined period for each image, and uses an image of which brightness level is lowest as the still image.

12. The display apparatus according to claim 10, wherein
the control unit analyzes frequency components of a plurality of images inputted during a predetermined period, and uses an image that includes the largest amount of low frequency components as the still image.

13. The display apparatus according to claim 8, wherein
the control unit performs processing to increase a contrast of the image displayed on the display panel in the period of decreasing the update frequency of the image to be higher than a contrast outside this period.

14. The display apparatus according to claim 8, wherein
the control unit performs processing to increase chroma of the image displayed on the display panel in a period of decreasing the update frequency of the image to be higher than chroma outside this period.

15. A method for controlling a display apparatus which includes a display panel, and a vibration member that vibrates the display panel,
the method comprising:
an output step of periodically acquiring an image and outputting the acquired image to the display panel; and
a correction step of vibrating the vibration member, wherein
in the output step, the update frequency of the image to be outputted to the display panel is decreased at least in a part of a period when the vibration member is vibrating, to be less than the update frequency outside the period.
